(19) United States
(12) Patent Application Publication
(10) Pub. No.: US 2015/0040158 A1
(43) Pub. Date: Feb. 5, 2015

(54) RECEIVING DEVICE, TRANSMITTER AND TRANSMITTING/RECEIVING SYSTEM

(71) Applicant: Kabushiki Kaisha Toshiba, Tokyo (JP)

(72) Inventor: Masahiro Kamida, Saitama-shi (JP)

(21) Appl. No.: 14/297,104

(22) Filed: Jun. 5, 2014

(30) Foreign Application Priority Data
Jul. 30, 2013 (JP) 2013-157964

(51) Int. Cl. H04N 21/475; H04N 21/27; H04N 21/61

(52) U.S. Cl. CPC H04N 21/475; H04N 21/6168; H04N 21/27
USPC 725/38

(57) ABSTRACT

According to one embodiment, a transmitting device transmits a data stream to a receiving device connected to the transmitting device via an MHL cable conforming to an MHL standard. The transmitting device includes a browser unit configured to generate a display screen comprising a character entry field for inputting characters. A stream output unit generates a data stream based on the display screen, and output the generated stream to the receiving device, a control signal receiving unit receives a control signal from the receiving device, and a character input unit generates a character string based on the control signal.

### CROSS-REFERENCE TO RELATED APPLICATIONS

This application is based upon and claims the benefit of priority from Japanese Patent Application No. 2013-157964, filed Jul. 30, 2013, the entire contents of which are incorporated herein by reference.

### FIELD

Embodiments described herein relate generally to a receiving device, a transmitter and a transmitting/receiving system.

### BACKGROUND

Electronic devices capable of recording and replaying video movies, TV programs and/or video content (streams) such as games, are now available.

Further, electronic devices conforming to standards for transmitting data streams, such as High Definition Multimedia Interface (HDMI) (trademark) and Mobile High-definition Link (MHL) (trademark), are also available.

An electronic device (source device) on the stream outputting side outputs data streams to an electronic device (sink device) on the stream receiving side. The sink device reproduces the received data streams and displays the reproduced video data on a display. Further, if the source and sink devices are connected to each other by MHL, they can control and operate each other.

For instance, there is a source device having a character entry function. In this case, when the sink device controls the source device, there is a case where the character entry function of the source device cannot be controlled because the operation module of the sink device does not conform to that of the source device.

It is an object of the invention to provide a receiving device, a transmitter and a transmitting/receiving system, which have further convenient properties.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view useful in explaining a transmitting/receiving system according to an embodiment;

FIG. 2 is a view useful in explaining the transmitting/receiving system according to the embodiment;

FIG. 3 is a view useful in explaining the transmitting/receiving system according to the embodiment;

FIG. 4 is a view useful in explaining the transmitting/receiving system according to the embodiment;

FIG. 5 is a flowchart showing an operation example of the transmitting/receiving system 1;

FIG. 6 is a view useful in explaining the transmitting/receiving system according to the embodiment;

FIG. 7 is a flowchart showing another example of the operation of the transmitting/receiving system 1; and

FIG. 8 is a view useful in explaining the transmitting/receiving system according to the embodiment.

### DETAILED DESCRIPTION

Various embodiments will be described hereinafter with reference to the accompanying drawings.

In general, according to one embodiment, a transmitter is configured to transmit a data stream to a receiving device connected to the transmitter via an MHL cable conforming to an MHL standard. The transmitter includes a browser unit, a data stream output controller, a control signal receiver, and a character input unit. The browser is configured to generate a display screen comprising a character entry field for inputting characters. The data stream output controller is configured to generate a data stream based on the display screen, and output the generated data stream to the receiver. The control signal receiver is configured to receive a control signal from the receiver. The character input controller is configured to generate a character string based on the control signal when the character entry field is selected by the control signal.

A receiver (it may be called a receiving device), a transmitter (it may be called a transmitting device) and a transmitting/receiving system according to an embodiment will be described in detail with reference to the accompanying drawings.

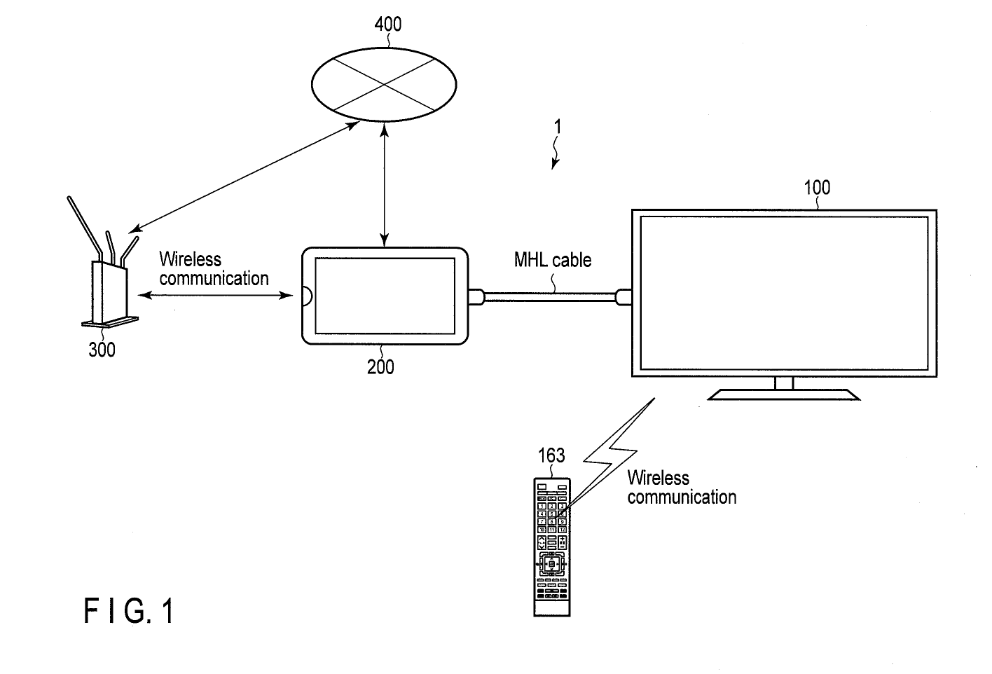

FIG. 1 shows an example of a transmitting/receiving system 1 comprising a plurality of electronic devices. As shown, the transmitting/receiving system 1 comprises a video processing device 100, a mobile device 200, a wireless communication terminal 300, etc.

The video processing device 100 is an electronic device, such as a broadcast receiving device capable of reproducing a broadcast signal or video content stored in a recording medium. The video processing device 100 can communicate by radio with a remote controller 163.

The mobile device 200 is an electronic device provided with a display, an operation unit and a communication unit. The mobile device 200 includes, for example, a mobile phone device, a tablet PC, a mobile music player, a game machine, a digital versatile disk (DVD) recorder, a set top box, and other electronic devices.

The wireless communication terminal 300 can communicate with the video processing device 100 and the mobile device 200 by wired or wireless communication. Namely, the wireless communication terminal 300 functions as a wireless access point. Further, the wireless communication terminal 300 can be connected to a network 400, such as an external cloud service. Namely, the wireless communication terminal 300 can access the network 400 in response to a request from the video processing device 100 or the mobile device 200. At this time, the video processing device 100 and the mobile device 200 can acquire various types of data from servers on the network 400 via the wireless communication terminal 300.

Furthermore, the video processing device 100 is connected to the mobile device 200 by a communication cable (MHL cable) conforming to MHL. The MHL cable has one terminal (HDMI terminal) of a shape corresponding to the HDMI standard, and the other terminal (USB terminal) of a shape corresponding to the USB standard (e.g., micro USB).

MHL is an interface standard for transmitting video data (streams) including video and audio data. In MHL, an electronic device (source device) on the stream outputting side outputs a data stream to an electronic device (sink device) on the stream receiving side by an MHL cable. The sink device can reproduce the received data stream and display the reproduced video data. Further, the source and sink devices can operate and control each other by transmitting a command to their destination device connected by the MHL cable.

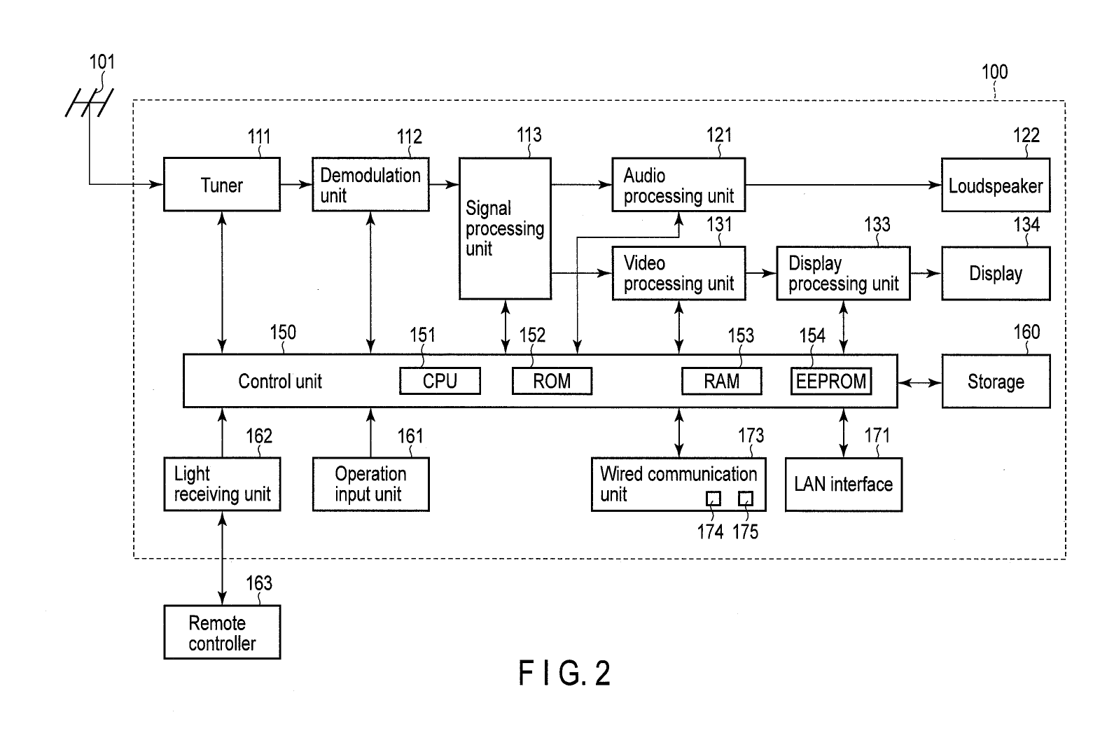

FIG. 2 shows an example of a video processing device 100 according to an embodiment.

The video processing device 100 is, for example, a broadcast receiving device capable of, for example, a broadcast signal or video content stored in a recording medium, or an electronic device such as a recorder.

The video processing device 100 comprises a tuner 111, a demodulation unit 112, a signal processing unit 113, an audio processing unit 121, a video processing unit 131, a display processing unit 133, a control unit 150, a storage 160, an operation input unit 161, a light receiving unit 162, a LAN interface 171, and a wired communication unit 173. The video processing device 100 also comprises a loudspeaker 122 and a display 134.

The tuner 111 can receive digital broadcasting signals through, for example, an antenna 101. The antenna 101 can receive, for example, terrestrial digital broadcasting signals, broadcasting satellite (BS) digital signals and/or 110-degree communication satellite (CS) digital broadcasting signals. The tuner 111 can receive content data (data streams), such as TV programs, carried by the above-mentioned digital broadcasting signals.

The tuner 111 is dedicated to digital broadcasting signals. The tuner 111 tunes the received digital broadcast signal. The tuner 111 transmits the tuned digital broadcast signal to a demodulation unit 112. The video processing device 100 may incorporate a plurality of tuners 111. The video processing device 100 can simultaneously tune a plurality of broadcasting signals using the plurality of tuners 111.

The demodulation unit 112 demodulates the received digital broadcasting signal, thereby acquiring video data (hereinafter referred to as a “data stream”), such as transport stream (TS), from the digital broadcasting signal. The demodulation unit 112 inputs the acquired data stream to the signal processing unit 113. The video processing device 100 may incorporate a plurality of demodulation units 112. The demodulation units 112 can demodulate the respective signals tuned by the tuners 111.

As described above, the antenna 101, the tuner(s) 111 and the demodulation unit(s) 112 function as stream receiving units.

The signal processing unit 113 performs signal processing such as selection of data streams. Namely, the signal processing unit 113 separates a data stream into a digital video signal, a digital audio signal and other data signals. The signal processing unit 113 can separate a plurality of data streams demodulated by a plurality of demodulation units 112. The signal processing unit 113 supplies a digital audio signal to the audio processing unit 121, supplies a digital video signal to the video processing unit 131, and supplies data signals to the control unit 150.

Under the control of the control unit 150, the signal processing unit 113 can convert the above-mentioned data stream into a recordable data stream (recording data stream). Under the control of the control unit 150, the signal processing unit 113 can supply the recording data stream to the storage 160 or to other modules.

Further, the signal processing unit 113 can change (transcode) the bit rate of the data stream from the original one to another one. Namely, the signal processing unit 113 can transcode the original bit rate of a data stream carried by, for example, a broadcasting signal into a lower bit rate. As a result, the signal processing unit 113 can record content in a less capacity state.

The audio processing unit 121 converts a digital audio signal received from the signal processing unit 113 into a signal (audio signal) of a format that permits the signal to be reproduced by the loudspeaker 122. For instance, the audio processing unit 121 converts a digital audio signal into an analog audio signal by digital-to-analog conversion, and supplies the resultant signal to the loudspeaker 122. The loudspeaker 122, in turn, reproduces a sound based on the supplied analog audio signal.

The video processing unit 131 converts a digital video signal received from the signal processing unit 113 into a video signal of a format that permits the signal to be reproduced by the display 134. Namely, the video processing unit 131 decodes (reproduces) the digital video signal received from the signal processing unit into a video signal of a format that permits the signal to be reproduced by the display 134, and outputs the video signal to the display processing unit 133.

Under the control of, for example, the control unit 150, the display processing unit 133 performs image quality adjustment processing on the received video signal associated with color, brightness, sharpness, contract, etc. The display processing unit 133 supplies the resultant video signal to the display 134, where a video image is displayed based on the supplied video signal.

The display 134 comprises, for example, a liquid crystal display panel including a plurality of pixels arranged in, for example, a matrix, and a backlight configured to illuminate the liquid crystal display panel. The display 134 displays a video image based on the video signal supplied from the display processing unit 133.

The video processing device 100 may comprise an output terminal configured to output video signals, instead of the display 134. Further, the video processing device 100 may comprise an output terminal configured to output audio signals, instead of the loudspeaker 122. Alternatively, the video processing device 100 may comprise an output terminal configured to output digital video and audio signals.

The control unit 150 functions as a control module configured to control the operation of each element of the video processing device 100. The control unit 150 comprises a CPU 151, a ROM 152, a RAM 153, an EEPROM (nonvolatile memory) 154, etc. The control unit 150 performs various types of processing based on operation signals supplied from the operation input unit 161.

The CPU 151 comprises, for example, an operation element configured to perform various operations. The CPU 151 realizes various functions by executing programs stored in the ROM 152, the EEPROM 154, etc.

The ROM 152 stores programs for controlling the video processing device 100 and realizing various functions. The CPU 151 activates a program stored in the ROM 152 in accordance with an operation signal from the operation input unit 161, thereby controlling the operation of each unit.

The RAM 153 functions as a work memory for the CPU 151. Namely, the RAM 153 stores, for example, the operation result of the CPU 151 and the data read by the CPU 151.

The EEPROM 154 is a nonvolatile memory configured to store various setting information items, programs, etc.

The storage 160 is a storing medium configured to store content. For instance, the storage 160 is formed of a hard disk drive (HDD), a solid state drive (SSD), a semiconductor memory, etc. The storage 160 can store recording data streams supplied from the signal processing unit 113.

The operation input unit 161 comprises, for example, a touch pad, or operation keys used by a user to generate an operation signal in accordance with a user's input operation. Alternatively, the operation input unit 161 may be configured to receive a signal from a keyboard, a mouse or another input device capable of generating an operation signal. The operation input unit 161 supplies an operation signal to the control unit 150.

The touch pad includes a device configured to generate position information using an electrostatic capacitive sensor, a thermo sensor or other means. Further, when the video processing device 100 incorporates the display 134, the operation input unit 161 may comprise a touch panel formed integral with the display 134 as one body.

The light receiving unit 162 comprises, for example, a sensor configured to receive an operation signal from the remote controller 163. The light receiving unit 162 supplies the received signal to the control unit 150. Upon receiving the signal, the control unit 150 amplifies the signal and performs analog-to-digital conversion of the amplified signal to decode the signal into the original operation signal sent from the remote controller 163.

The remote controller 163 has various operation keys. The remote controller 163 generates operation signals in accordance with the operations of the respective keys, and outputs the generated operation signals. Thus, the remote controller 163 generates operation signals based on user's input operations. The remote controller 163 sends the generated operation signal to the light receiving unit 162 by infrared communication. The light receiving unit 162 and the remote controller 163 may be configured to transmit and receive operation signals utilizing other wireless communication based on, for example, radiation wave.

The remote controller 163 comprises numerical keys for causing the video processing device 100 to perform input operations, such as channel selection and input of a character string. The remote controller 163 also comprises cursor keys for enabling the video processing device 100 to perform various types of processing. The cursor keys include, for example, a cross key, a decision key, a program table key, a recorded content list key, a return key and an end key. The video processing device 100 performs, for example, selection of various items on the screen, based on operation signals corresponding to the cross key and the decision key.

The LAN interface 171 can communicate with other devices on the network 400 via the wireless communication terminal 300 connected to the LAN interface 171 by a wired or wireless LAN. As a result, the video processing device 100 can communicate with other devices connected to the wireless communication terminal 300. For instance, the video processing device 100 can acquire, via the LAN interface 171, a data stream recorded on a device connected to the network 400, and reproduce it.

The wired communication unit 173 is an interface configured to perform communication based on a standard, such as HDMI or MHL. The wired communication unit 173 comprises a plurality of HDMI terminals (not shown) that can be connected to HDMI and MHL cables, an HDMI processing unit 174 configured to perform signal processing based on the HDMI standard, and an MHL processing unit 175 configured to perform signal processing based on the MHL standard.

The terminal, which is incorporated in the MHL cable and is to be connected to the video processing device 100, has a structure compatible with the HDMI cable. The MHL cable has a resistor connected between terminals (detection terminals) that are not used for communication. The wired communication unit 173 can detect by applying a voltage between the detection terminals whether the MHL cable or the HDMI cable is connected to the HDMI terminal.

The video processing device 100 can receive and reproduce the data stream output from a device (source device) connected to the HDMI terminal of the wired communication unit 173. Further, the video processing device 100 can output a data stream to a device (sink device) connected to the HDMI terminal of the wired communication unit 173.

The control unit 150 provides the signal processing unit 113 with the data stream received from the wired communication unit 173. The signal processing unit 113 separates, for example, a digital video signal and a digital audio signal from the received data stream. The signal processing unit 113 supplies the separated digital video signal to the video processing unit 131, and supplies the separated digital audio signal to the audio processing unit 121. Thus, the video processing device 100 can reproduce the data stream received from the wired communication unit 173.

Further, the video processing device 100 also comprises a power supply unit (not shown). The power supply unit receives power from, for example, a commercial power supply via an AC adaptor, and converts the received AC power into a DC power to thereby distribute it to each element of the video processing device 100.

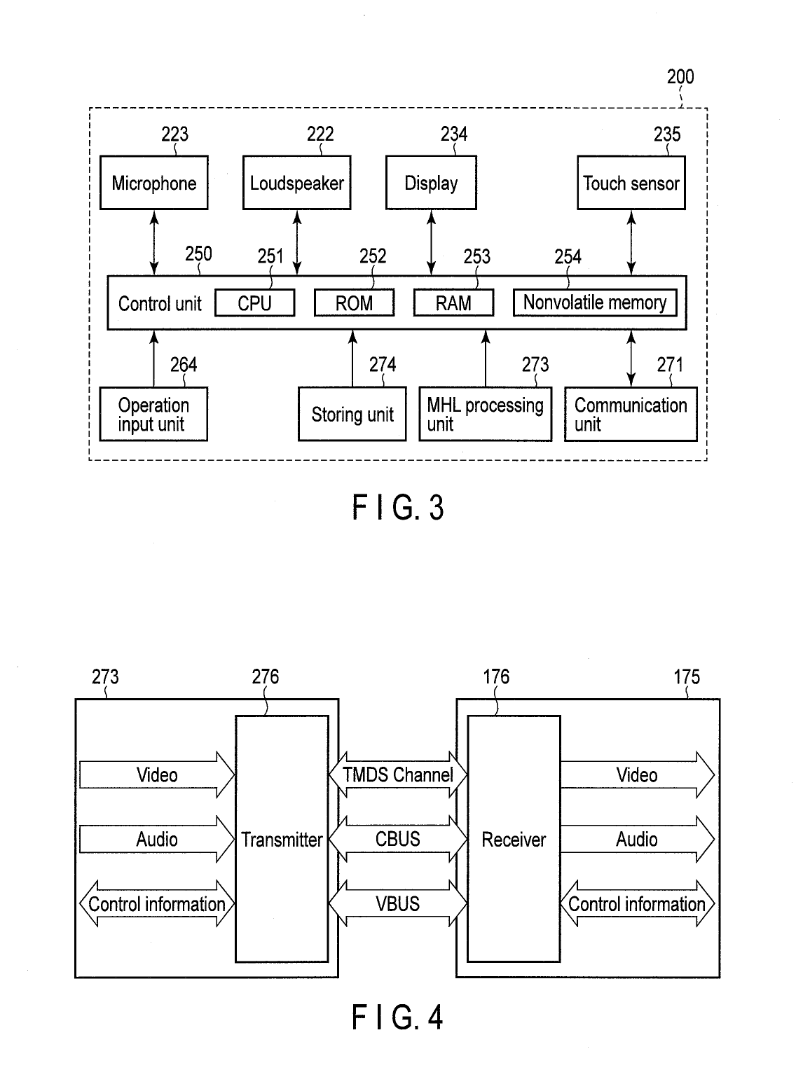

FIG. 3 shows an example of the mobile device 200 according to the embodiment.

The mobile device 200 comprises a control unit 250, an operation input unit 264, a communication unit 271, an MHL processing unit 273 and a storing unit 274. The mobile device 200 also comprises a loudspeaker 222, a microphone 223, a display 234 and a touch sensor 235.

The control unit 250 functions to control the operation of each element of the mobile device 200. The control unit 250 comprises a CPU 251, a ROM 252, a RAM 253, a nonvolatile memory 254, etc. The control unit 250 performs various types of processing based on operation signals supplied from the operation input unit 264 or the touch sensor 235.

The CPU 251 comprises, for example, an operation element configured to perform various operations. The CPU 251 realizes various functions by executing programs stored in the ROM 252, the nonvolatile memory 254, etc.

The ROM 252 stores programs for controlling the mobile device 200 and realizing various functions. The CPU 251 activates a program stored in the ROM 252 in accordance with an operation signal from the operation input unit 264, thereby controlling the operation of each unit.

The RAM 253 functions as a work memory for the CPU 251. Namely, the RAM 253 stores, for example, the operation result of the CPU 251 and the data read by the CPU 251.

The nonvolatile memory 254 stores various setting information items, programs, etc.

Further, the CPU 251 can perform various types of processing based on the data, such as applications, stored in the storing unit 274.

Further, the control unit 250 can generate video signals for various screens in accordance with the application executed by the CPU 251, and display images corresponding to the signals on the display 234. The control unit 250 can also generate audio signals corresponding to various sounds in accordance with the application executed by the CPU 251, and output the audio signals to the loudspeaker 222.

The loudspeaker 222 reproduces sounds based on the supplied audio signals.

The microphone 223 is a sound collector configured to generate a signal (recording signal) based on a sound outside the mobile device 200, and to supply the recording signal to the control unit 250.

The display 234 comprises, for example, a liquid crystal display panel with a plurality of pixels arranged in a matrix, and a backlight for illuminating the liquid crystal display panel. The display 234 displays a video corresponding to a video signal.

The touch sensor 235 is a device configured to generate position information using an electrostatic capacitive sensor, a thermo sensor or other means. For instance, the touch sensor 235 is formed integral with the display 234 as one body. As a result, the touch sensor 235 can generate an operation signal based on an operation on the screen of the display 234, and supply the signal to the control unit 250.

The operation input unit 264 comprises keys used for generating an operation signal in accordance with, for example, a user's input operation. The operation input unit 264 comprises, for example, a volume adjusting key for adjusting the volume of a sound, a luminance adjusting key for adjusting the luminance of the display 234, and a power supply key for turning on and off the mobile device 200. The operation input unit 264 may further comprise a track ball configured to cause the mobile device 200 to perform various selection operations. The operation input unit 264 generates an operation signal in accordance with the aforementioned key operation and supplies it to the control unit 250.

Alternatively, the operation input unit 264 may be configured to receive a signal from a keyboard, a mouse or another input device capable of generating an operation signal. For instance, when the mobile device 200 incorporates a USB terminal or a Bluetooth (trademark) module, the operation input unit 264 receives an operation signal from an input device connected via the USB terminal or the Bluetooth module, and supplies it to the control unit 250.

The communication unit 271 can communicate with a device on the network 400 via the wireless communication terminal 300 utilizing a wired or wireless LAN. Further, the communication unit 271 can communicate with other devices on the network 400 via a mobile phone network. Thus, the mobile device 200 can communicate with devices connected to the wireless communication terminal 300. For instance, the mobile device 200 can acquire and play back video data, picture data, music data and web content recorded in devices on the network 400.

The MHL processing unit 273 is an interface configured to perform communications based on the MHL standard. The MHL processing unit 273 performs signal processing based on the MHL standard. Further, the MHL processing unit 273 has a USB terminal (not shown) to which an MHL cable can be connected.

The mobile device 200 can receive and reproduce data streams output from a device (source device) connected to the USB terminal of the MHL processing unit 273. Further, the mobile device 200 can output data streams to a device (sink device) connected to the USB terminal of the MHL processing unit 273.

Yet further, the MHL controller 273 can generate a stream by multiplexing a video signal to be displayed and an audio signal to be played back. Namely, the MHL processing unit 273 can generate a data stream containing video data to be displayed on the display 234 and audio data to be output through the loudspeaker 222.

For instance, when the MHL processing unit 273 has its USB terminal connected to an MHL cable, and functions as a source device, the control unit 250 supplies video signal to be displayed and an audio signal to be reproduced to the MHL controller 273. Using the video signal to be displayed and an audio signal to be reproduced, the MHL processing unit 273 can generate data streams of various formats (e.g., 1080i, 60 Hz). Namely, the mobile device 200 can convert, into a data stream, a display image to be displayed on the display 234 and a sound to be reproduced through the loudspeaker 222. The MHL controller 273 can output the generated data stream to a sink device connected to the USB terminal.

The mobile device 200 further comprises a power supply unit (not shown). The power supply unit comprises a battery, and a terminal (e.g., a DC jack) to be connected to an adaptor configured to receive power from, for example, a commercial power supply. The power supply unit charges the battery with power received from the commercial power supply. Further, the power supply unit supplies the power charged in the battery to each element of the mobile device 200.

The storing unit 274 comprises a hard disk drive (HDD), a solid state drive (SSD) or a semiconductor memory. The storing unit 274 can store programs to be executed by the CPU 251 of the control unit 250, applications, content such as video data, and various types of data.

FIG. 4 shows an example of communication based on the MHL standard. In this embodiment, assume that the mobile device 200 is a source device, and the video processing device 100 is a sink device.

As shown in FIG. 4, the MHL processing unit 273 of the mobile device 200 comprises a transmitter 276, and a receiver (not shown). Similarly, the MHL processing unit 175 of the video processing device 100 comprises a transmitter (not shown) and a receiver 176.

The transmitter 276 and the receiver 176 are connected to each other by an MHL cable. The MHL cable has lines, such as VBUS, GND, CBUS, MHL+ and MHL−.

The VBUS is a line configured to transmit power. For instance, the sink device supplies the source device with a power of +5 V through the VBUS. The source device can be driven by the power supplied from the sink device through the VBUS. For example, the power supply unit of the mobile device 200 as the source device can charge its battery with the power supplied from the sink device through the VBUS. The GND is a grounded line.

The CBUS is a line configured to transmit a control signal such as a command. The CBUS is used to bi-directionally transmit, for example, a display data channel (DDC) command or an MHL sideband channel (MSC) command. The DDC command is used to, for example, read extended display identification data (EDID) and verify high-bandwidth digital content protection (HDCP). The EDID is a list of display information items preset in accordance with the specifications of, for example, a display. The MSC command is used for, for example, reading/writing data from/to various registers (not shown) and remote controller control.

More specifically, the video processing device 100 as the sink device outputs a command to the mobile device 200 as the source device through the CBUS. The mobile device 200 can execute various types of processing in accordance with received commands.

The source device can perform HDCP verification by sending a DDC command to the sink device, to thereby read EDID from the sink device.

HDCP is a standard for encrypting a signal transmitted between devices. The video processing device 100 and the mobile device 200 perform mutual authentication by performing transmission/reception of, for example, a key in a procedure conforming to the HDCP. If the video processing device 100 and the mobile device 200 have been mutually authenticated, they can mutually transmit and receive encrypted signals. In the middle of the HDCP authentication between the mobile device 200 and the video processing device 100, the mobile device 200 reads EDID from the video processing device 100.

Alternatively, the mobile device 200 may acquire the EDID from the video processing device 100, not in the middle of the HDCP authentication, but at another time.

The mobile device 200 analyzes the EDID acquired from the video processing device 100 to detect display information indicating formats, such as resolution, color depth and transmission frequency, that can be dealt with by the video processing unit 100. The mobile device 200 generates a data stream of formats, such as resolution, color depth and transmission frequency, that can be dealt with by the video processing unit 100.

The MHL+ and MHL− are lines configured to transmit data. The two lines MHL+ and MHL− function as one twist pair line. For instance, the MHL+ and MHL− function as TMDS channels configured to transmit data by a transition minimized differential signaling (TMDS) standard. Further, the MHL+ and MHL− can transmit a synchronization signal (MHL clock) of the TMDS standard.

For instance, the source device can output a data stream to the sink device via a TMDS channel. Namely, the mobile device 200 functioning as the source device can provide the video processing device 100 with a data stream, into which the video data (display screen) to be displayed on the display 234 and the sound to be output from the loudspeaker 222 are converted. The video processing device 100 receives the data stream sent through the TMDS channel, and performs preset signal processing on it to reproduce it.

The video processing device 100 can activate a browser configured to enable a user to browse various types of information on the network, by executing a program or application stored in the nonvolatile memory 154. The video processing device 100 can perform various type of processing on the browser in accordance with operation signals. For instance, the video processing device 100 can perform, for example, selection of an item on the browser, and selection of a character entry field in accordance with an operation signal.

By executing a program or application stored in the nonvolatile memory 154, the video processing device 100 can activate a software keyboard (character entry function) that enables the user to select a character on the screen to thereby generate a character string. In accordance with an operation signal, the video processing device 100 causes the user to select a key corresponding to a character on the software keyboard. The video processing device 100 can generate a character string in accordance with the selected keys.

When the browser is activated in accordance with the operation, the video processing device 100 selects an item on the browser in accordance with an operation of the cursor key of the remote controller 163. Further, when the character entry field on the browser is selected by an operation of the cursor key, the video processing device 100 activates the software keyboard. The video processing device 100 can generate a character string by operating a numeral key on the software keyboard, and output the generated character string to the mobile device 200 through the MHL cable.

The storing unit 274 or the nonvolatile memory 254 of the mobile device 200 stores, for example, an operating system (OS) and various applications executable on the OS. The storing unit 274 or the nonvolatile memory 254 comprises, for example, a browsing application (browser application) and a character input application.

The browser application is a browser for browsing the Internet. The character input application is a program (character entry function) for facilitating character input by the touch sensor 235.

The mobile device 200 can activate the browser for enabling the user to browse various information items on the network, by executing the browser application stored in the storing unit 274 or the nonvolatile memory 254. The mobile device 200 can perform various types of processing on the browser in accordance with operation signals. For instance, the mobile device 200 can perform, for example, selection of an item on the browser and selection of a character entry field.

Further, the mobile device 200 can activate a software keyboard configured to enable the user to select a character on the screen to thereby generate a character string, by executing a second character input application stored in the storing unit 274 or the nonvolatile memory 254. The mobile device 200 enables the user to select, for example, a key corresponding to a character on the software keyboard, in accordance with an operation signal. The mobile device 200 can generate a character string in accordance with the selected key. The mobile device 200 inputs the generated character string in the character entry field. Further, the mobile device 200 can receive a character string output from the video processing device 100 via the MHL cable. In this case, the mobile device 200 inputs the received character string in the character entry field.

As a result, the mobile device 200 can acquire data from the network 400, using the character string input in the character entry field as a keyword, and display the acquired data on the display 234.

The video processing device 100 may generate a control signal for controlling the mobile device connected by the MHL cable, based on an operation signal generated by the remote controller 163 or the operation input unit 161. In this case, the video processing device 100 sends a control signal to the mobile device 200 through the CBUS of the MHL cable. Thus, the video processing device 100 controls the operation of the browser application of the mobile device 200.

In the description below, the character entry function of the video processing device 100 will be referred to as “the first character entry function,” and the character entry function of the mobile device 200 will be referred to as “the second character entry function.”

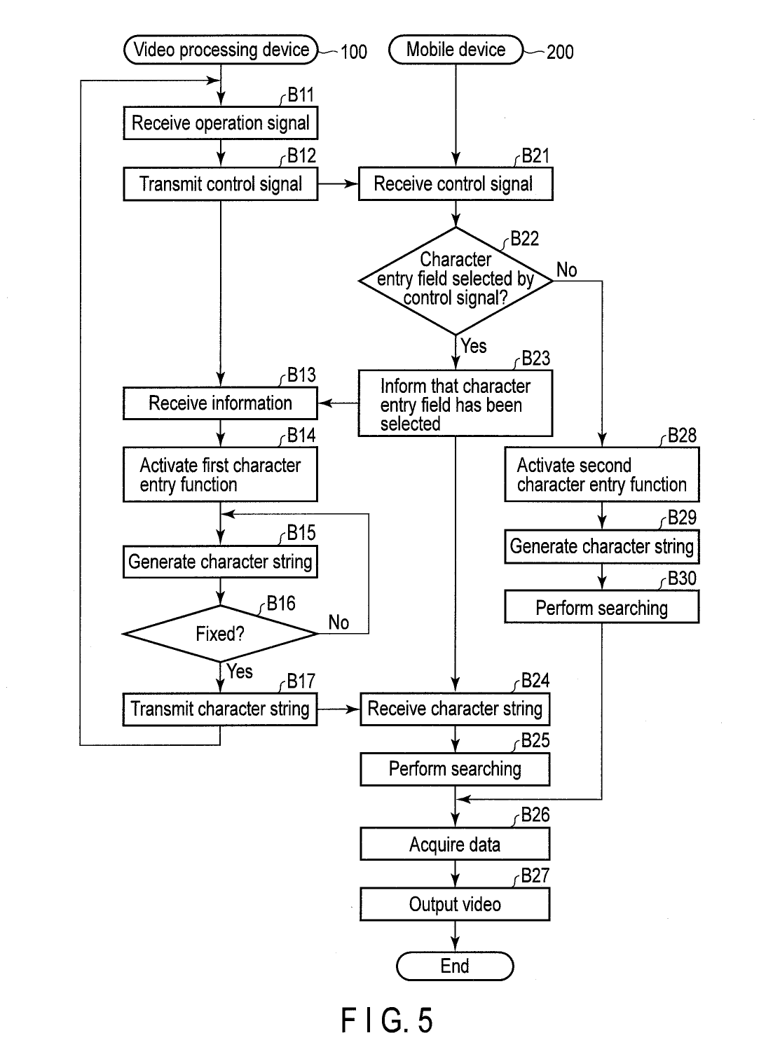

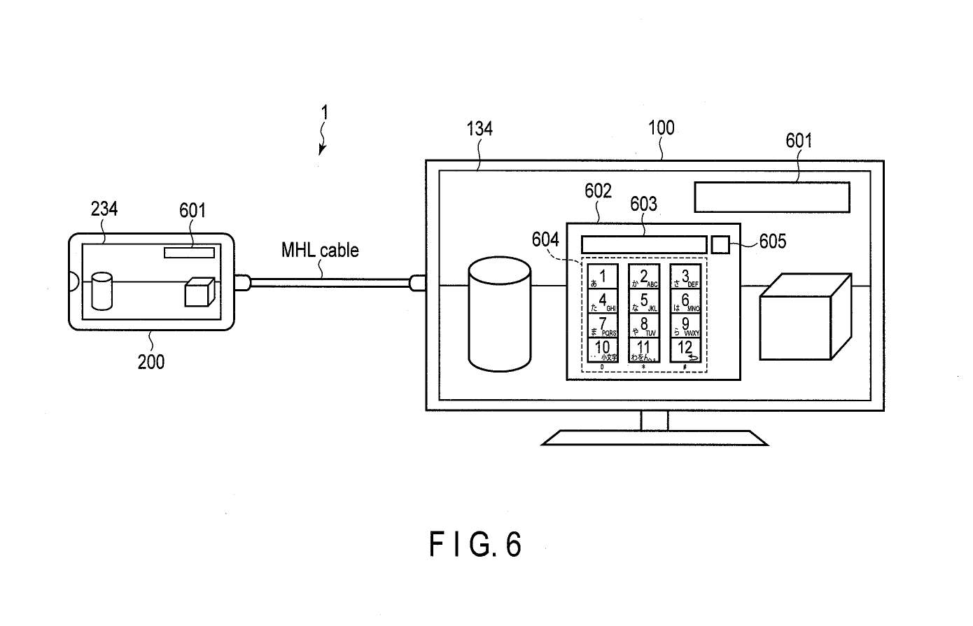

FIG. 5 shows an operation example of the transmitting/receiving system 1. More specifically, FIG. 5 shows a case where a browser is operating on the mobile device 200. Further, FIG. 6 shows a example of a case when video data is output from the mobile device 200 to the device 100 through the MHL cable.

The video processing device 100 receives an operation signal from the remote controller 163 (block B11), and generates a control signal based on the operation signal. The video processing device 100 sends the generated control signal to the mobile device 200 through the MHL cable (block B12).

The mobile device 200 receives the control signal from the video processing device 100 through the MHL cable (block B21), and executes an operation on the browser in accordance with the received control signal. Further, the mobile device 200 executes an operation on the browser in accordance with an operation signal generated by the touch sensor 235 of the operation input unit 264. Namely, the mobile device 200 operates the browser based on the control signal output from the video processing device 100 or the operation signal generated by the operation module of the mobile device 200.

For instance, as shown in FIG. 6, the mobile device 200 displays a screen including a character entry field 601 on the display 234. Further, the mobile device 200 outputs a data stream to the video processing device 100 through the MHL cable. As a result, the video processing device 100 can display the display screen of the mobile device 200 on the display 134. Thus, the video processing device 100 can display a screen including the character entry field 601 on the display 134.

further, the mobile device 200 can detect whether the character entry field has been selected on the browser of the mobile device 200. Upon detecting that the character entry field has been selected on the browser, it is determined whether the operation of selecting the character entry field has been made based on the control signal output from the video processing device 100, or on the operation signal generated by the operation module of the mobile device 200 (block B22).

If it is determined that the operation of selecting the character entry field has been made based on the control signal output from the video processing device 100, the mobile device 200 generates information indicating that the character entry field has been selected, and sends it to the video processing device 100 through the MHL cable (block B23).

The video processing device 100 receives the information indicating that the character entry field has been selected (block B13). At this time, the video processing device 100 activates the first character entry function (block B14).

When the video processing device 100 has activated the first character entry function, it displays, on the display 134, a window 602 for inputting a character. At this time, the video processing device 100 superposes the window 602 on the data stream output form the mobile device 200.

The window 602 comprises a display area 603, a character keypad 604, and a decision key 605. The display area 603 is where a character string input using the character keypad 604 is displayed.

The character keypad 604 comprises a plurality of keys corresponding to, for example, the numeric keys of the remote controller 163. Namely, the character keypad 604 is an input interface configured to make characters to correspond to the numeric keys of the remote controller 163. The control unit 150 of the video processing device 100 generates a character string in accordance with an operation on the character keypad 604. The control unit 150 displays the generated character string on the display area 603.

The decision key 605 is used to fix the character string displayed on the display area 603.

The video processing device 100 can generate a character string, based on an operation on the numeric keys of the remote controller 163 when the window 602 is displayed (block B15).

The video processing device 100 executes generation of a character string until the character string is fixed (block B16). For example, the video processing device 100 fixes the character string in accordance with an operation on the decision key 605. The video processing device 100 can select the decision key 605 based on the operation of the cursor key or decision key of the remote controller 163.

When the decision key 605 has been selected, the video processing device 100 sends the character string, displayed in the display area 603, to the mobile device 200 through the MHL cable (block B17).

The mobile device 200 receives the character string from the video processing device 100 (block B24). At this time, the mobile device 200 displays the received character string in the character entry field 601 on the display screen.

Further, the mobile device 200 performs searching on the network 400, using the character string in the character entry field 601 as a keyword (block B25). As a result, the mobile device 200 can acquire data from the network 400 (block B26). The mobile device 200 displays the acquired data on the display 234 (block B27). In this case, the mobile device 200 can also display the data acquired from the network 400 on the display 134 of the video processing device 100.

Also, if it is determined in block B22 that the operation of selecting the character entry field has been made by the operation module of the mobile device 200, the control unit 250 of the mobile device 200 activates the second character entry function (block B28).

If the second character entry function is activated, the mobile device 200 displays, on the display 234, a window for inputting characters. At this time, the mobile device 200 generates a character string in accordance with an operation performed while a second character input application is being activated (block B29).

Subsequently, the mobile device 200 executes searching on the network 400, using the character string generated in block B29 as a keyword (block B30). Thus, the mobile device 200 acquires data from the network 400 (block B26). The mobile device 200 displays the acquired data on the display 234 (block B27). At this time, the mobile device 200 can also display, on the display 134 of the video processing device 100, the data acquired from the network 400 based on the character string generated at the mobile device 200.

As described above, when the character entry field in the application of the mobile device 200 has been selected based on a signal sent from the video processing device 100 as the sink device, the mobile device 200 informs the video processing device 100 that the character entry field has been selected. At this time, the video processing device 100 executes its own first character entry function to thereby generate a character string and then send the character string to the mobile device 200.

Thus, when the character entry field has been selected by an operation on the sink device side, the mobile device 200 can cause the sink device to execute the first character entry function operable by the sink device. Namely, the video processing device 100 as the sink device can control the character entry function of the mobile device 200 as the source device. As a result, a receiving device, a transmitting device and a transmitting/receiving system, which have more convenience, can be provided.

Alternatively, the mobile device 200 may have a structure for causing the video processing device 100 to control the second character entry function of the mobile device 200, instead of using a character string generated by the first character entry function of the video processing device 100.

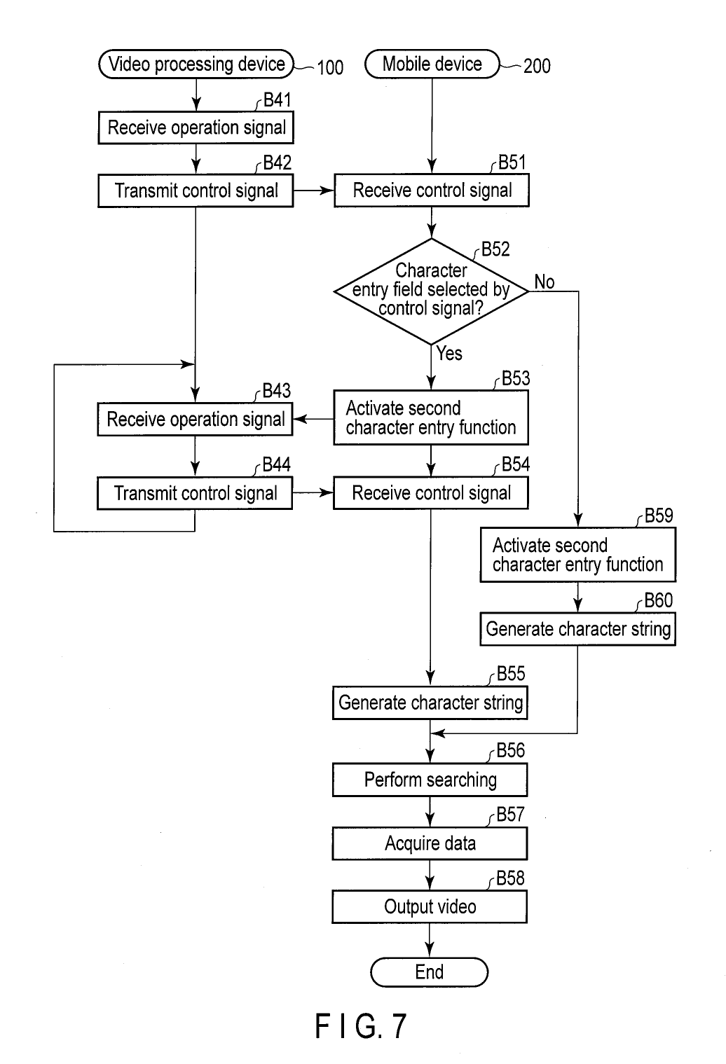

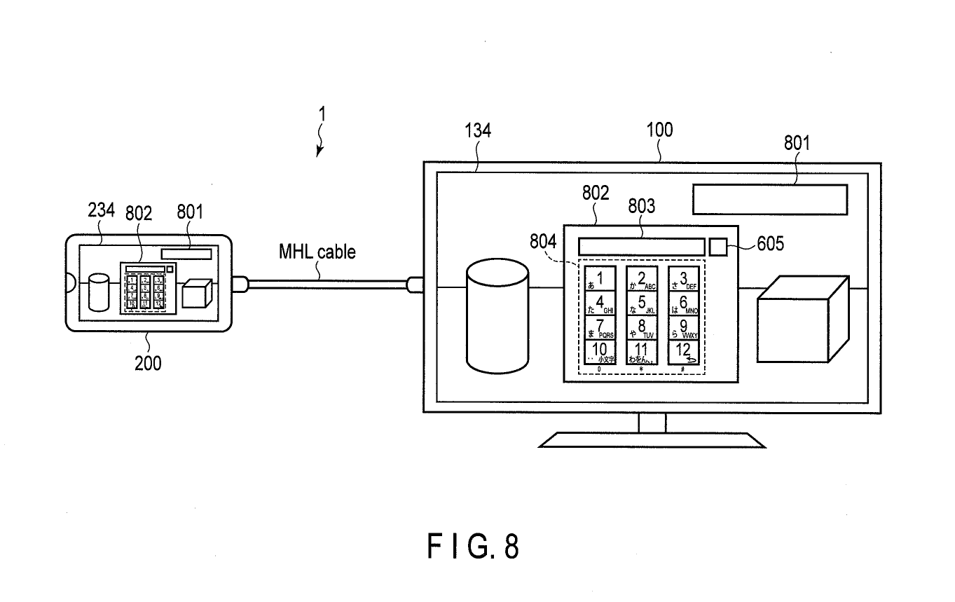

FIG. 7 shows another example of the operation of the transmitting/receiving system 1. More specifically, FIG. 7 shows the operation performed when a browser is being activated on the mobile device 200. FIG. 8 shows an example of display assumed while video data is being output from the mobile device 200 to the video processing device 100 through the MHL cable.

The video processing device 100 receives an operation signal sent from the remote controller 163 (block B41), generates a control signal using the received operation signal, and sends the generated control signal to the mobile device 200 through the MHL cable (block B42).

The mobile device 200 receives the control signal from the video processing device 100 through the MHL cable (block B51). By operating in accordance with the received control signal, the mobile device 200 performs an operation on the browser. Further, the mobile device 200 performs an operation on the browser in accordance with an operation signal generated by the touch sensor 235 or the operation input unit 264. Namely, the mobile device 200 operates the browser based on the control signal output from the video processing device 100 or the operation signal generated by the operation module of the mobile device 200.

For instance, as shown in FIG. 8, the mobile device 200 displays a screen including a character entry field 801 on the display 234. Further, the mobile device 200 outputs a data stream to the video processing device 100 through the MHL cable. As a result, the video processing device 100 can display the display screen of the mobile device 200 on the display 134. Namely, the video processing device 100 can display a screen including the character entry field 801 on the display 134.

Further, the mobile device 200 can detect that the character entry field has been selected on the browser of the mobile device 200. If it is detected that the character entry field has been selected on the browser, the mobile device 200 determines whether the operation of selecting the character entry field has been made based on the control signal output from the video processing device 100 or on the operation signal generated by the operation module of the mobile device 200 (block B52).

If it is determined that the operation of selecting the character entry field 801 has been made based on the control signal output from the video processing device 100, the mobile device 200 activates the second character entry function (block B53). When the second character entry function has been activated as above, the mobile device 200 displays, on the display 134, a window 802 for inputting characters (block B53).

The window 802 is an input interface for generating a character string based on a signal sent from the video processing device 100 as the sink device. The mobile device 200 holds a plurality of types of character entry screens in the storing unit 274 or the nonvolatile memory 254.

The mobile device 200 reads a character entry screen from the storing unit 274 or the nonvolatile memory 254, based on the type, specification, etc., of the video processing device 100 connected to the device 200 via the MHL cable. Using the read character entry screen, the mobile device 200 generates the window 802. Namely, the mobile device 200 can cause the display 234 and the display 134 of the video processing device 100 to display the window 802 corresponding to the video processing device 100 connected to the device 200 via the MHL cable.

The window 802 displays a display area 803, a character key unit 84 and a decision key 805. The display area 803 is configured to display a character string input using the character key unit 804.

The character key unit 804 comprises a plurality of keys corresponding to, for example, the numeral keys of the remote controller 163 of the video processing device 100. In other words, the character key unit 804 is an input interface configured to make characters correspond to the numerical keys of the remote controller 163.

The video processing device 100 receives an operation signal sent from the remote controller 163 (block B43). The video processing device 100 generates a control signal to be sent to the mobile device 200, using the received operation signal, and sends the generated control signal to the mobile device 200 via the MHL cable (block B44). Thus, the video processing device 100 generates a control signal whenever it receives a signal from the remote control 163, and outputs the control signal to the mobile device 200.

The mobile device 200 receives the control signal from the video processing device 100 (block B54). At this time, the mobile device 200 generates a character string based on the received control signals (block 355), and displays the generated character string in the display area 803 on the display screen. Thus, the mobile device 200 can sequentially display character strings in the display area 803 displayed on the display 134 of the video processing device 100.

The decision key 805 is used to fix the character string displayed in the display area 803.

For instance, when receiving a control signal to select the decision key 805 from the video processing device 100, the control unit 250 of the mobile device 200 determines that the decision key 805 has been selected. At this time, the mobile device 200 fixes the character string displayed in the display area 803. Namely, the mobile device 200 inputs, into the character entry field 801, the character string in the display area 803. Based on the operation of, for example, the cursor key and the decision key of the remote controller 163, the video processing device 100 can generate a control signal for selecting the decision key 805.

As described above, when receiving, from the video processing device 100, a control signal for selecting the decision key 805, the mobile device 200 executes searching on the network 400, using, as a keyword, the character string displayed in the character entry field 801 on the display screen (block B56). As a result, the mobile device 200 can acquire data from the network 400 (block B57), and display the data on the display 234 (block B58). At this time, the mobile device 200 can also display, on the display 134 of the video processing device 100, the data acquired from the network 400 based on the character string generated by operating the video processing device 100.

Further, if it is determined at block B52 that the operation of selecting the character entry field has been made based on an operation signal generated by the operation module of the mobile device 200, the control unit 250 of the mobile device 200 activates the second character entry function (block B59).

When the second character entry function has been activated, the mobile device 200 displays a window for inputting characters on the display 234. At this time, the mobile device 200 generates a character string in accordance with an operation during the activation of the second character input application (block B60).

In addition, the mobile device 200 executes searching on the network 400, using the character string generated in block B60 as a keyword (block B56). As a result, the mobile device 200 can acquire data from the network 400 (block B57). The mobile device 200 can display the acquired data on the display 234 (block B58). At this time, the mobile device 200 can also display, on the display 134 of the video processing device 100, the data acquired from the network 400 based on the character string generated by operating the mobile device 200.

As described above, when the character entry field in the application of the mobile device 200 has been selected based on a signal sent from the video processing device 100 as the sink device, the mobile device 200 activates the second character entry function. Further, the mobile device 200 sequentially generates character strings based on signals sent from the video processing device 100.

Consequently, when the character entry field has been selected by operating the sink device, the mobile device 200 can cause the sink device to control the second character entry function, whereby a receiving device, a transmitting device and a transmitting/receiving system, which are more convenient, can be provided.

Although in the above-described embodiment, the video processing device 100 has the first character entry function, the embodiment is not limited to this. The video processing device 100 may not have the first character entry function, but may be constructed such that the mobile device 200 determines whether the video processing device 100 has the first character entry function, and switches processing in accordance with the determination result.

For instance, if it is determined that the video processing device 100 has the first character entry function, the mobile device 200 executes processing in blocks B23 to B25 in FIG. 5, and causes the video processing device 100 to execute processing in blocks B23 to B25 in FIG. 5.

Further, if it is determined that the video processing device 100 does not have the first character entry function, the mobile device 200 executes processing in blocks B53 to B55 in FIG. 7, and causes the video processing device 100 to execute processing in blocks B43 and B44 in FIG. 7.

Thus, the mobile device 200 can perform switching to realize an appropriate character input method, depending upon whether the video processing device 100 has the first character entry function.

Alternatively, the mobile device 200 may be constructed such that the character entry method is switched based on a predetermined setting. Namely, the mobile device 200 may be constructed such that setting as to whether the processing shown in FIG. 5 or FIG. 7 should be performed is beforehand made.

The functions described in the embodiment can be constructed not only by hardware but also by software. In the latter case, the functions can be realized by causing a computer to read programs corresponding to the functions. Further, each of the functions may be selectively realized by software or hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmitter configured to transmit a data stream to a receiver connected to the transmitter via an MHL cable conforming to an MHL standard, comprising:
a browser configured to generate a display screen comprising a character entry field for inputting characters;
a data stream output controller configured to generate a data stream based on the display screen, and output the generated data stream to the receiver;
a control signal receiver configured to receive a control signal from the receiver; and
a character input controller configured to generate a character string based on the control signal when the character entry field is selected by the control signal.

2. The transmitter of claim 1, wherein the character input controller activates a character entry function incorporated in the receiver when the character entry field is selected by the control signal.

3. The transmitter of claim 1, wherein the character input controller superposes a character entry screen for inputting characters on the display screen, when the character entry field is selected by the control signal.

4. The transmitter of claim 3, wherein
the character input controller comprises a plurality of character entry screens preset in accordance with types of receivers; and
the character input controller superposes one of the character entry screens corresponding to the receiver on the display screen, when the character entry field is selected by the control signal.

5. A receiver configured to receive a data stream from a transmitter connected to the receiver via an MHL cable conforming to an MHL standard, comprising:
a data stream receiver configured to receive a data stream from the transmitter;
a data stream reproducing controller configured to reproduce the data stream;
a control signal generator configured to generate a control signal based on an input operation;
a control signal transmitter configured to transmit the control signal to the transmitting; and
a character input controller configured to generate a character string in accordance with an operation and send the generated character string as the control signal to the transmitting, when the character entry field is selected by the control signal at the transmitter.

6. A transmitting and receiving system comprising a transmitter configured to transmit a data stream, and a receiver connected to the transmitter via an MHL cable conforming to an MHL standard and configured to receive the data stream from the transmitter,
wherein
the transmitter comprises:
a browser configured to generate a display screen comprising a character entry field for inputting characters;
a data stream output controller configured to generate a data stream based on the display screen, and output the generated data stream to the receiver;
a control signal receiver configured to receive a control signal from the receiver; and
a first character input controller configured to generate a first character string based on the control signal when the character entry field is selected by the control signal, and
the receiver comprises:
a data stream receiver configured to receive the data stream from the transmitter;
a data stream reproducing controller configured to reproduce the data stream;
a control signal generator configured to generate the control signal based on an input operation;
a control signal transmitter configured to transmit the control signal to the transmitter; and
a second character input controller configured to generate a second character string in accordance with an operation and send the generated second character string as the control signal to the transmitter, when the character entry field is selected by the control signal at the transmitter.
